(19) United States
(12) Patent Application Publication
(10) Pub. No.: US 2005/0105295 A1
(43) Pub. Date: May 19, 2005

(54) Japanese character text automotive lamp

(76) Inventor: Kern Christopher Barthol, Houston, TX (US)

Correspondence Address: KERN CHRIS BARTHOL, 10710 CONCHO ST., HOUSTON, TX, 77072, US

(21) Appl. No.: 10/712,502

(22) Filed: Nov. 13, 2003

(51) Int. Cl. B60Q 1/00

(52) U.S. Cl. 362/459; 362/812

(57) ABSTRACT

An automotive lamp with a housing (10) that is of sufficient size and shape so that it may properly fit its respected vehicle in which it was intended to be mounted upon. At the rear of the lamp are sufficient housing attachment devices (12) in the exact positions as the original factory automotive lamp as well as adequate electrical lighting component attachment points (16) for the respected vehicle's original electrical lighting components (18). On the interior of the housing (10) of the lamp are light shaping channels (14) which are used to display a number, word, or any combination of the two in Japanese character text (14).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to automotive lamps.

### BACKGROUND OF INVENTION

Since the dawn of the horseless carriage, people have searched for ways to modify their vehicles in some way or another to make theirs different from others. This is often referred to as auto enthusiasm. Modifications can range from something as simple as a steering wheel cover, to a fully customized makeover resulting in something totally different from the vehicle's original state.

Over the years automobile manufacturers have tried to capitalize on this need for uniqueness by providing accessories and options when new models are released. Extras such as gold trimming packages, alloy wheels, and even spoilers are available, but not without its cost. Most automobile consumers are neither in a financial position to, nor have the desire to pay a dealer's price for customization. Automotive enthusiasm is not new but during the past decade a new type of auto enthusiast has evolved, the enthusiast of Japanese automobiles. Enthusiasts of Japanese automobiles are always searching for new, inexpensive ways to modify their vehicles.

This demand for low cost customization has created 3^{rd} party manufacturers that offer much wider selections of custom products at a fraction of the cost that would normally be paid to a dealer. One of the more successful lines of products offered by 3^{rd} party manufacturers is their aftermarket automotive lamps. These can range from head lamps to side markers to tail lamps. While 3^{rd} party automotive lamps usually differ somewhat from the factory lamps provided by automobile manufacturers, they still lack the type of customization that an enthusiast of Japanese automobiles or even an enthusiast of Japanese nationality for that matter would appreciate. These consumers currently have to settle for what is available. Aside from that, most custom products purchased from 3^{rd} party manufacturers don't really convey what they would like them to, and that is, their love for their Japanese vehicle and/or nationality.

These days, owners of Japanese autos as well as auto owners of Japanese nationality like to show the pride that they have for their vehicles and/or nationality through their vehicles but currently suffer from many disadvantages due to this lack of available products that display these emotions.

Some of these disadvantages are:

(a) Consumers usually have to pay a much higher price for customization products if purchased through a dealer;

(b) It is difficult, if at all possible, to find a customization product that is mainly for the enthusiast of Japanese nationality from a dealer as well as 3^{rd} party manufacturers at this point in time;

(c) It is difficult, if at all possible, to find a customization product that is mainly for the enthusiast of Japanese automobiles from a dealer as well as 3^{rd} party manufacturers at this point in time;

(d) Most customizations are difficult, time consuming processes that also come with the risk of damaging the vehicle while modifying it.

### BACKGROUND OF INVENTION—OBJECTS AND ADVANTAGES

Japanese Character Text Automotive Lamps will start a new revolution in automotive customization. Accordingly, several objects and advantages of this invention are:

(a) to provide a customization product that will appeal to enthusiasts of Japanese nationality;

(b) to provide a customization product that will appeal to enthusiasts of Japanese automobiles;

(c) to relieve consumers from the much higher prices of a dealer's customization products;

(d) to provide a form of customization that once is completed can easily be reversed;

(e) to provide a form of customization that can be done in little time;

(f) to provide a form of customization that will not damage the vehicle during the modification process.

Further objects and advantages are to provide a customization product for auto enthusiasts that are neither of Japanese origin, nor own a Japanese vehicle, but have an appreciation for the Japanese culture and/or language and would like to display it on his or her vehicle.

### SUMMARY

In accordance with the present invention, a Japanese Character Text Automotive Lamp comprises of an automotive lamp with a means for displaying a number, word, or any combination of the two in Japanese character text.

### DRAWINGS—FIGURES

In the drawings, closely related figures have the same number but different alphabetic suffixes.

FIG. 1A shows a perspective view of the front of a preferred embodiment.

FIG. 1B shows a perspective view of the rear of the preferred embodiment.

FIG. 2A shows a perspective view of the front of an additional embodiment.

FIG. 2B shows a perspective view of the rear of the additional embodiment.

FIG. 3 shows the operation of the preferred embodiment.

### DRAWINGS—REFERENCE NUMERALS

10 Lamp Housing
12 Lamp Housing Attachment Device
14 Light Shaping Channel/Japanese Character Text
16 Electrical Lighting Component Attachment Point
18 Electrical Lighting Component
20 Lamp Housing Attachment Point

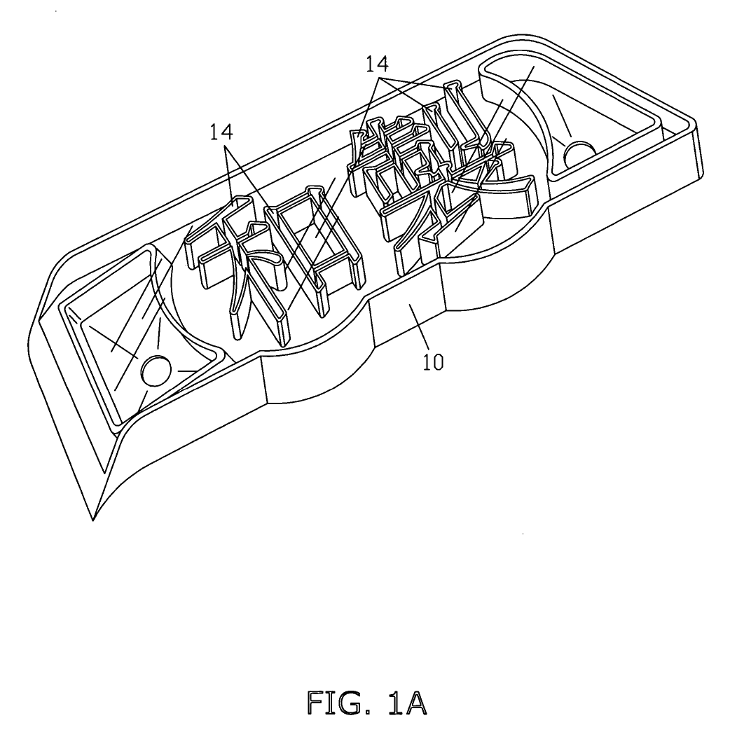

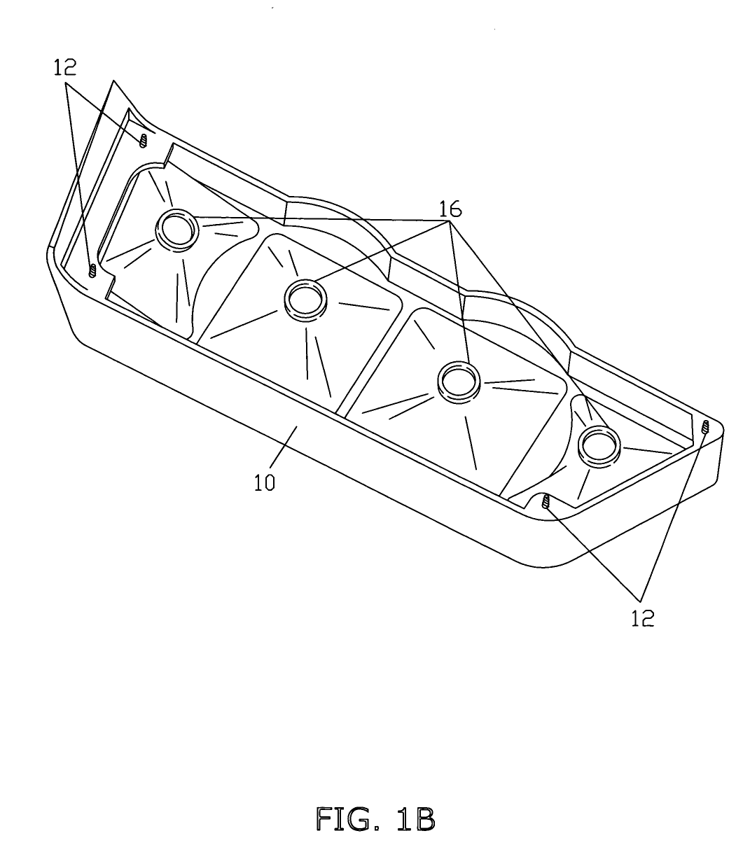

### DETAILED DESCRIPTION—FIGS. 1A and 1B—PREFERED EMBODIMENT

There are numerous forms of writing in Japanese. Many from the past have evolved to become the ones used in the present. The most popular forms in use today are Kanji, Katakana, Hiragana, and Romaji. Romaji is the translation of the Japanese language to Roman letters and Arabic numerals. The Japanese Character Text Automotive Lamp primarily refers to using Kanji, Katakana, and Hiragana but is not restricted to using only those forms of writing.

A preferred embodiment of the Japanese Character Text Automotive Lamp is shown in FIGS. 1A and 1B. The Japanese character text 14 in these illustrations means “Japanese Made”. This particular lamp may appeal to someone who favors vehicles of Japanese origin and would like to display it. The lamp has a housing 10 in the size and shape of the original factory lamp of its respected vehicle to ensure a correct fit. It has sufficient electrical lighting component attachment points 16 for the original electrical lighting components 18 of its respected vehicle. The lamp has adequate housing attachment devices 12 in the exact positions as the original factory lamp to ensure proper mounting to its respected vehicle. The desired Japanese Character Text is displayed using light shaping channels 14.

Light shaping channels are simply hollowed out versions of the text that is desired to be displayed. As a result, when light is transmitted from the vehicles original electrical lighting components 18, excess light is blocked and only the light that is needed to display the desired text is allowed to pass through. To enhance the brilliance of the light, a light reflective material may be used to line the walls of the interior of the light shaping channels 14.

The Japanese Character Text Automotive Lamp can be made using plastic, carbon fiber, polyurethane, or any equivalent material that the manufacturer may see fit to use.

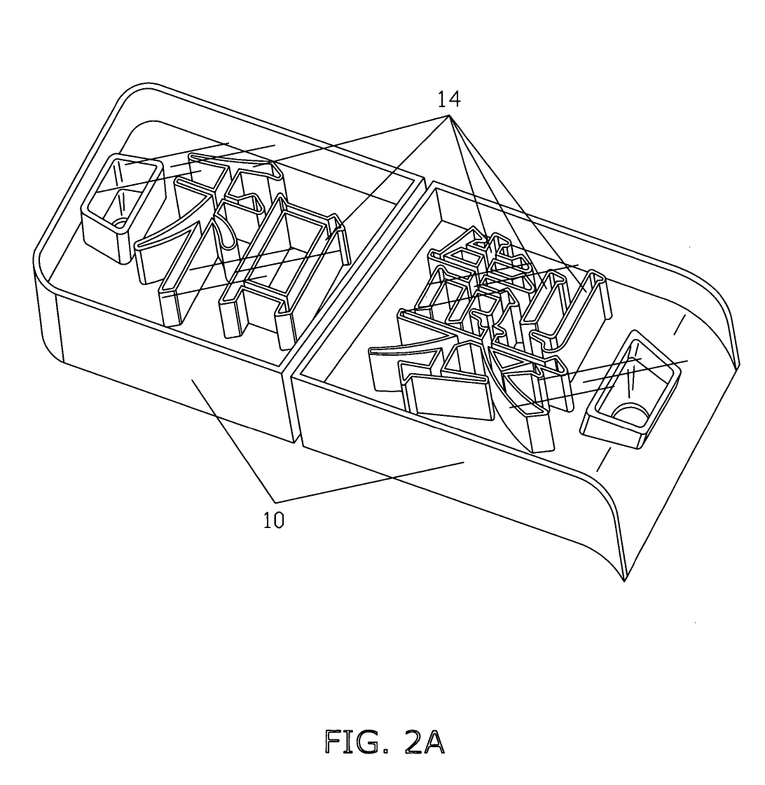

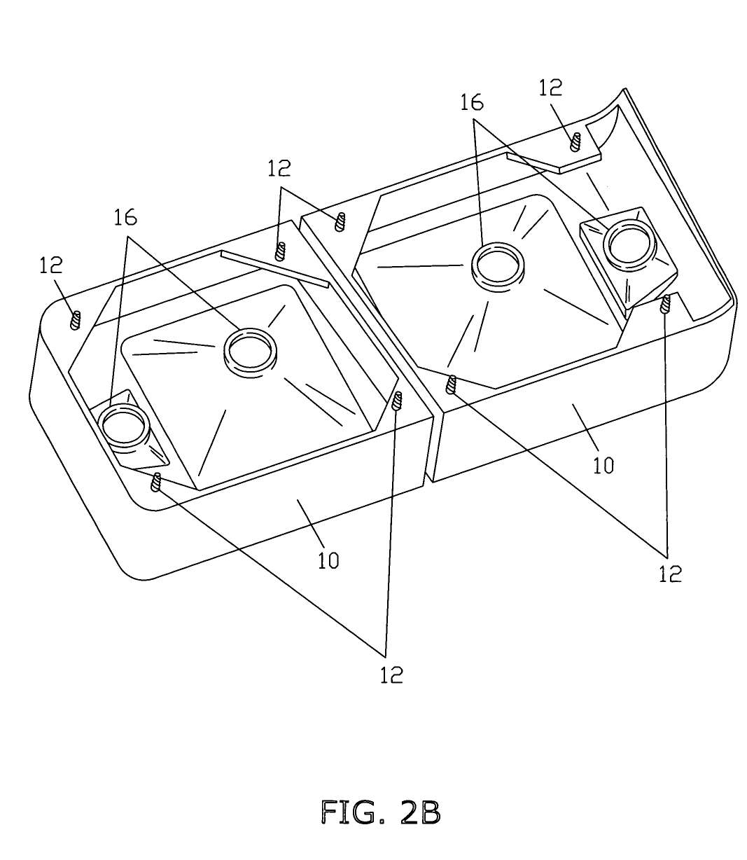

FIGS. 2A and 2B—Additional Embodiment

A possible additional embodiment is shown in FIGS. 2a and 2b. This is an example of one of the many additional embodiments that a Japanese Character Text Automotive Lamp can have. Being that there are hundreds of thousands of different makes, models and years of vehicles on the road today from the past as well as the present, each with their own unique lamps of different sizes and shapes, the possibilities of additional embodiments are endless. There are also future automobiles that are not on the market yet to be considered as well. If automobiles of the past, present, and the future are kept in mind, there would be an infinite number of additional embodiments.

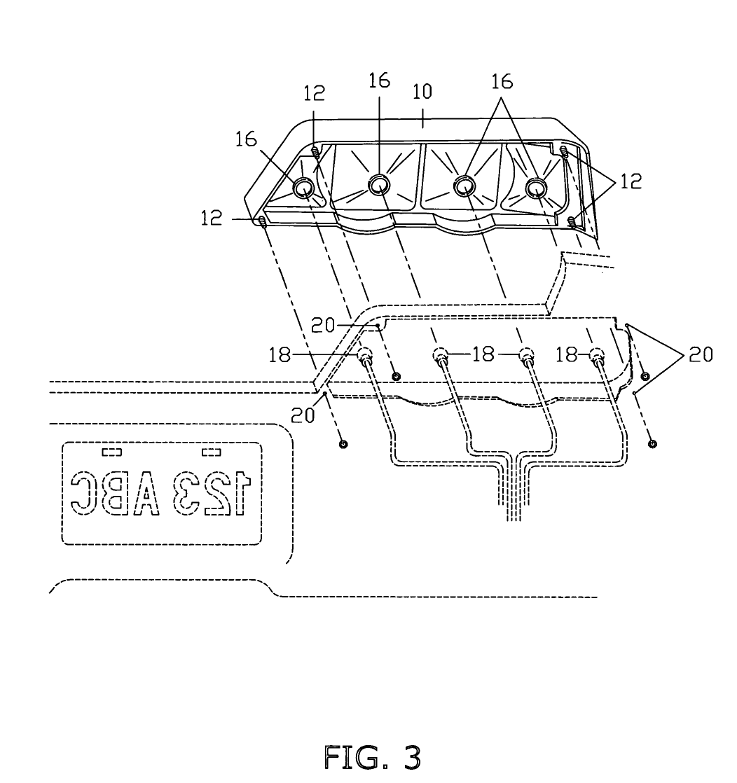

Operation—Fig. 3

The manner of using the Japanese Character Text Automotive Lamp is identical to that of automotive lamps in present use. First, one must disconnect any and all of the vehicle's original electrical lighting components 18 that provide illumination from the rear of the original factory automotive lamp and then detach the lamp itself from the vehicle. Next, one must then attach the Japanese Character Text Automotive Lamp manufactured for that specific vehicle in place of the original automotive lamp and reconnect any of the vehicle's original electrical lighting components 18 that were disconnected from the vehicle's original automotive lamp. Once the Japanese Character Text Automotive Lamp is in place of the original lamp and the original electrical lighting components 18 are reconnected, the Japanese Character Text Automotive Lamp is ready for operation. Now during daylight hours, the number, or word that is meant to be displayed in Japanese character text will be displayed to everyone within view. At night when visibility is low, the number or word that is meant to be displayed will be illuminated by the vehicle's electrical lighting components 18.

Advantages

From the description above, a number of advantages of my Japanese Character Text Automotive Lamp become evident:

(a) It will take relatively no time at all to install;

(b) There is moderately no chance of vehicle damage during installation;

(c) Reversing this modification will be effortless being that it is a simple bolt on product;

(d) It will appeal to auto enthusiasts of Japanese automobiles and Japanese nationality alike;

(e) It will appeal to auto enthusiasts that are neither of Japanese nationality nor own a vehicle of Japanese origin, but have an appreciation for the Japanese language and/or culture and would like to display it on his or her vehicle.

Conclusion, Ramifications, and Scope

Accordingly, the reader will see that the Japanese Character Text Automotive Lamp solves a multitude of problems such as:

customization projects that can consume a massive amount of time;

customization projects that can damage the vehicle during the modification process;

customizations that once are completed cannot be undone;

the lack of customization products that appeal to enthusiasts of Japanese automobiles as well as enthusiasts of Japanese nationality.

Ramifications can include:

different colored automotive lamps;

using an arrangement of light emitting diodes (LEDs) or neon lighting to form the shape of the Japanese character text rather than using light shaping channels;

rearranging and/or changing the orientation of the Japanese character text;

using any of the thousands of characters in the Japanese language other than those shown in this application.

Even though the description above contains much specificity, these should not be considered as restrictions to the scope of the invention, but as simply providing illustrations of some of the currently favored embodiments of this invention. For example, the lamp can be manufactured in whatever size and shape that is required to fit the respected vehicle it is intended to be mounted upon.

Thus the scope of the invention should be determined by the appended claims and their legal equivalents, rather than by the examples given.

1. An automotive lamp comprising:
a housing and a means to display a number or word in Japanese character text from said housing of said automotive lamp.
